(19) United States
(12) Patent Application Publication
(10) Pub. No.: US 2003/0070286 A1
(43) Pub. Date: Apr. 17, 2003

(54) Tool setting device

(76) Inventors: Jeffrey L. Chalmers, Ferndale, MI (US); Jack R. Gaudreau, New Hudson, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 09/978,404

(22) Filed: Oct. 16, 2001

(51) Int. Cl. B23P 11/02; B23P 19/00

(52) U.S. Cl. 29/800; 29/447

(57) ABSTRACT

A device is disclosed for setting the shank of a rotary cutting tool in a throughbore of a heat shrink fit tool holder so that the rotary cutting tool is at the same position as the shank of a reference cutting tool positioned in the throughbore of a reference holder. The device comprises a housing having a first station and a second station laterally spaced from the first station. A reference is positioned at the first station while a second fixture adapted to receive the tool is mounted to the housing at a second station. A first rod is movably mounted to the housing along an axis aligned with the reference tool and a second rod is movably mounted to the housing and aligned with the second fixture while a crossbeam is secured to the first and second rods so that the rods move in unison with each other. The crossbeam and rods are moved upwardly until the first rod abuts against the bottom of the reference cutting tool. After the tool holder is heated, the rotary cutting tool is inserted into the tool holder until the rotary cutting tool abuts against the top of the second rod.

### BACKGROUND OF THE INVENTION

I. Field of the Invention

The present invention relates generally to a device for accurately positioning a rotary cutting tool in a heat shrink fit tool holder at the same position of a reference tool mounted within a reference holder.

II. Description of the Prior Art Heat shrink fit tool holders are used in many industrial manufacturing operations. Such tool holders include a throughbore of a predetermined diameter and are adapted to be mounted to the spindle of a rotary drive machine.

Each rotary cutting tool used with such previously known shrink fit tool holders has an outside diameter greater than the inside diameter of the holder throughbore. Thus, in order to position the cutting tool within the tool holder, the holder is inductively heated thus expanding the whole diameter of the tool holder. When the tool holder is sufficiently heated above a predetermined temperature, the tool holder throughbore becomes larger than the outside diameter of the cutting tool. At that time, the cutting tool is positioned within the tool holder throughbore and the tool holder is cooled. Upon cooling, the tool holder thermally contracts thus gripping the shank of the cutting tool and securing the cutting tool to the tool holder.

A primary advantage of utilizing shrink fit tool holders is that such tool holders are relatively inexpensive to manufacture. A primary disadvantage, however, of shrink fit tool holders is that, once the tool holder has cooled, the axial position of the cutting tool relative to the tool holder cannot be adjusted without first reheating the tool holder. For that reason, in situations where the axial position of the rotary cutting tool relative to the tool holder is critical, it is necessary to accurately position the shank of the cutting tool in the tool holder prior to allowing the tool holder to cool and frictionally attach to the cutting tool.

There have been a number of previously known machines for accurately positioning the cutting tool in a shrink fit tool holder. These previously known devices typically used complex gauging circuitry and gauging sensors in order to accurately position the cutting tool in the tool holder prior to allowing the tool holder to cool. While these previously known devices were effective in operation, they were disadvantageously expensive in construction and oftentimes required trained personnel to operate.

### SUMMARY OF THE PRESENT INVENTION

The present invention provides a device for setting a cutting tool in a shrink fit tool holder so that the cutting tool shank is at the same position as the shank of a reference tool positioned in a reference tool holder which overcomes all of the above-mentioned disadvantages of the previously known devices.

In brief, the device of the present invention comprises a housing having a first station and a second station. The first station and second station are laterally spaced from each other.

A first fixture is mounted to the housing at the first station. This fixture is adapted to receive and support the reference holder at a predetermined position. Furthermore, the first fixture includes an opening aligned with the throughbore formed in the reference holder.

Similarly, a second fixture is mounted to the housing at the second station. This second fixture is adapted to receive and support the tool holder which will receive the cutting tool such that the tool holder is at a predetermined position relative to the housing. The second fixture also has an opening aligned with the tool holder throughbore.

A first rod is movably mounted to the housing along an axis aligned with the first fixture opening while, similarly, a second rod is movably mounted to the housing along an axis aligned with the second fixture opening. A crossbeam is secured to the first and second rods so that the rods move in unison with each other.

In order to move the crossbeam, and thus the rods, along their respective axes, a ball screw or similar device is rotatably mounted to the housing and threadably engages a nut in the crossbeam. Consequently, rotation of the ball screw displaces the rods in unison with each other along their vertical axes of movement. A controllable servo motor is preferably used to rotatably drive the ball screw although, alternatively, the ball screw can be manually rotatably driven or rotatably driven by other conventional means.

An induction coil is mounted to the housing around the second station so that the induction coil circumscribes the tool holder positioned at the second fixture at the second station. Upon energization of the induction coil, the induction coil heats the tool holder thus thermally expanding the tool holder as well as the diameter of its throughbore.

An upwardly extending column is mounted to the housing adjacent the second station while a plunger is movably mounted to the column along an axis aligned with the tool holder throughbore. The plunger, furthermore, is adapted to releasably support the cutting tool. Thus, when the tool holder has reached a predetermined temperature, actuation of the plunger from its retracted position and to its extended position inserts the shank of the cutting tool into the throughbore of the tool holder. Alternatively, the cutting tool can be hand loaded into the tool holder.

In operation, the reference holder with the reference tool is positioned on the first fixture at the first station. The ball screw is then activated until the top of the first rod abuts against the bottom of the reference tool in the reference holder. The tool is then preset to a specific height.

The tool holder adapted to receive the cutting tool is then positioned on the second fixture at the second station and the induction coil is activated to inductively heat the tool holder. When the tool holder attains a predetermined temperature, the plunger holding the cutting tool is moved from its retracted position and to its extended position thus positioning the shank of the cutting tool into the tool holder throughbore. The plunger is actuated until the bottom of the cutting tool abuts against the top of the second rod. Since the position of the top of the second rod is fixed with respect to the position of the top of the first rod, the cutting tool can be positioned in the tool holder at precisely the same position as the reference tool in the reference holder.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a front partial diagrammatic view illustrating the preferred embodiment of the present invention; and

FIGS. 2-4 are all fragmentary sectional views illustrating the operation of the preferred embodiment of the present invention.

### DETAILED DESCRIPTION OF A PREFERRED EMBODIMENT OF THE PRESENT INVENTION

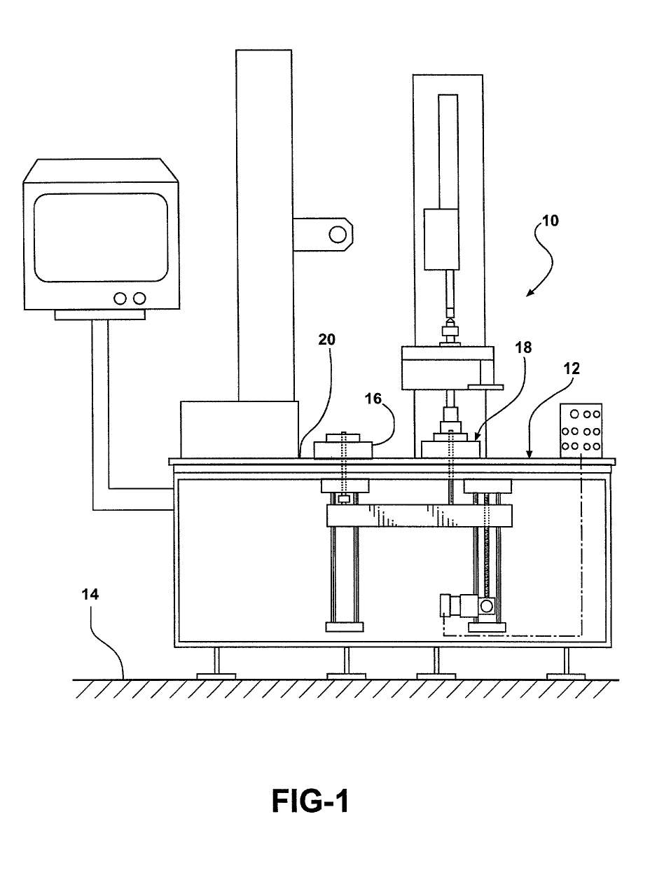

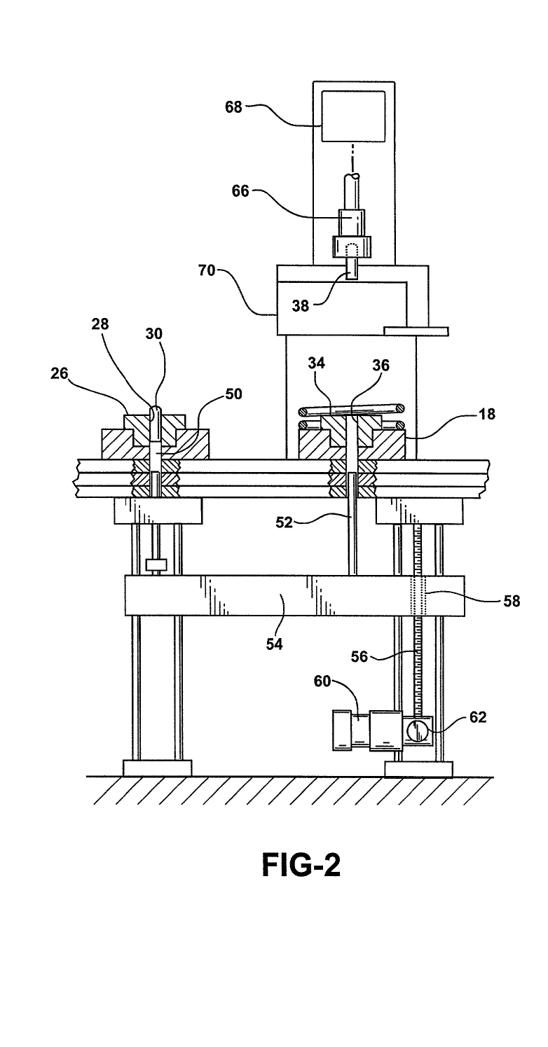

With reference first to FIGS. 1 and 2, a preferred embodiment of the device 10 for setting the shank of a cutting tool in a shrink fit tool holder so that the cutting tool shank is at the same position as the shank of a reference tool positioned in a reference holder is shown. The device 10 comprises a housing 12 which is stationarily supported on a ground support surface 14.

A first station 16 and second station 18 are provided on the housing 12 so that the stations 16 and 18 are laterally spaced from each other. Preferably, the stations 16 and 18 are horizontally aligned with each other along a top 20 of the housing 12.

With reference now particularly to FIG. 2, a fixture 22 having a throughbore 24 is mounted at the first station 16. This fixture 22, furthermore, is adapted to receive and support a reference tool holder 26 having a throughbore 28. Furthermore, a reference cutting tool 30 is positioned within the throughbore 28 of the reference holder 26 at a preset position. In addition, with the reference holder 26 positioned in the fixture 22, the reference holder throughbore 28 is aligned with the fixture opening 24.

Still referring to FIG. 2, a second fixture 30 having a throughbore 32 is mounted at the second station 18. The second fixture 30, furthermore, is adapted to receive and support a tool holder 34 having a throughbore 36 such that the tool holder throughbore 36 is aligned with the fixture opening 32. In a manner which will be subsequently described in greater detail, the device 10 of the present invention is operable to accurately position a new cutting tool 38 in the tool holder 34 such that the new cutting tool 38 is positioned within the tool holder 34 at the same position as the reference tool 30 is positioned with the reference holder 26.

The tool holder 34 is a heat shrink tool holder. As such, the diameter, at room temperature of the tool holder throughbore 36 is less than the diameter of the shank of the cutting tool 38. Consequently, in order to position the shank of the cutting tool 38 in the throughbore 36, it is necessary to thermally heat the tool holder 34 to a temperature sufficiently high that the tool holder 34 thermally expands and the diameter of the tool holder throughbore 36 is greater than the shank of the cutting tool 38. Any conventional induction coil 40, or other equivalent means, can be used to thermally heat the tool holder 34.

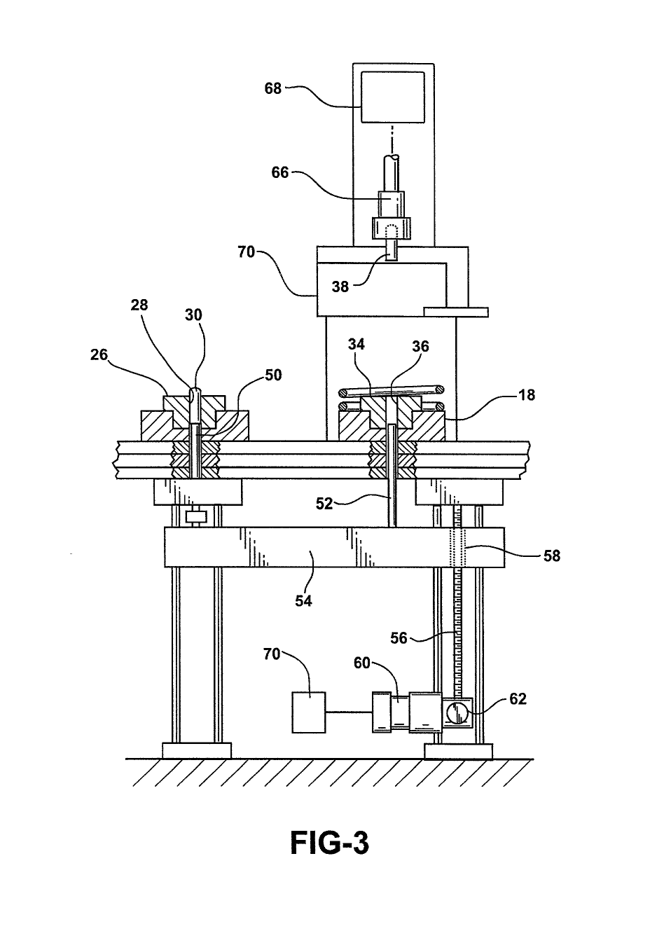

With reference now to FIGS. 2 and 3, a first rod 50 is longitudinally vertically movably mounted to the housing 12 such that the rod 50 is aligned with the opening 28 of the first fixture 22 as well as the throughbore 28 of the reference holder 26. Similarly, a second rod 52 is vertically movably mounted to the housing 12 such that the second rod 52 is aligned with the opening 32 in the second fixture 30 as well as the tool holder throughbore 36. The rods 50 and 52, furthermore, are secured together by a crossbeam 54 so that the rods 50 and 52 move in unison with each other.

In order to vertically move the beam 54, and thus the rods 50 and 52, an externally threaded shaft 56, such as a ball screw, is rotatably mounted to the housing 12. The shaft 56 threadably engages a nut 58 in the crossbeam 54 so that rotation of the shaft 56 vertically displaces the crossbeam 54 together with its attached rods 50 and 52. Any conventional means, such as a servo motor 60 and gearbox 62, may be used to rotatably drive the shaft 56. Other types of motors may alternatively be used without deviation from the spirit or scope of the invention. Indeed, if desired, the shaft 56 can be manually rotatably driven by an appropriate crank or other means.

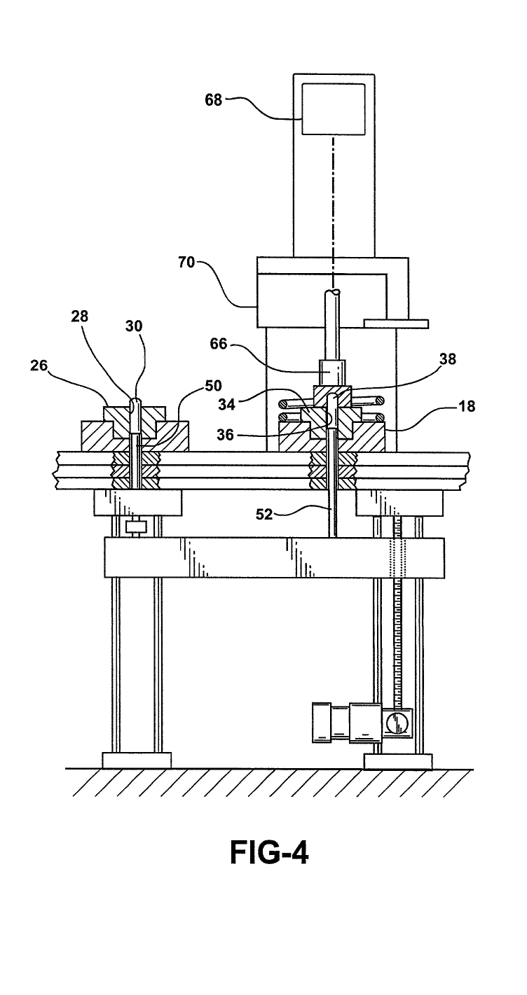

With reference now to FIGS. 3 and 4, the cutting tool 38, i.e. the tool adapted to be positioned within the tool holder 34 at the same position as the reference tool 30 in the reference holder 26, is releasably carried by a plunger assembly 66 which is illustrated only diagrammatically. The plunger assembly 66 is movable between a retracted position, illustrated in FIG. 3, and an extended position, illustrated in FIG. 4. Any conventional means 68 may be employed to move the plunger between its extended and its retracted position and preferably the means 68 is mounted on a vertically extending column 70 mounted to the housing 12 adjacent the second station 18.

In operation and with reference first to FIG. 2, the reference holder 26 is first positioned within the first fixture 22. At this time, an upper end of the rod 50 is spaced downwardly from the bottom of the reference tool 30.

A cutting tool holder 34 is then positioned within the second fixture 30 at the second station 18. Additionally, a new cutting tool 38 is positioned within the plunger assembly 66 when the plunger assembly 66 is in its retracted position such that the cutting tool 38 is spaced upwardly from the tool holder 34.

With reference now to FIG. 3, the motor 60 is actuated using any conventional control circuitry 70 (illustrated only diagrammatically in FIG. 3) to vertically displace the crossbeam 54 with its attached rods 50 and 52 to move the rods from the position shown in FIG. 2 and to the position shown in FIG. 3 in which the upper end of the first rod 50 abuts against the bottom of the reference tool 30. In doing so, the upper end of the second rod 52 is positioned within the throughbore 36 of the tool holder 34 at the same position that the upper end of the first rod 50 is positioned within the throughbore 28 of the reference holder 26.

With reference now to FIG. 4, the induction coil 40 is activated thus heating the tool holder 34 to a temperature sufficiently high such that the diameter of the tool holder throughbore 36 is greater than the outside diameter of the cutting tool 38. At that time, the means 68 is actuated thus moving the plunger assembly 66 from its retracted position (FIG. 3) to its extended position (FIG. 4) thus positioning the cutting tool 38 in the tool holder 34 until the lower end of the cutting tool 38 abuts against the upper end of the second rod 52. In doing so, the cutting tool 38 is positioned in the tool holder 34 at the same position as the reference tool 30 is positioned within the reference holder 26.

The induction coil 40 is then deactivated thus allowing the tool holder 34 to cool and thermally contract around the shank of the cutting tool 38 thus securing the tool holder 34 and cutting tool 38 together. The plunger assembly is moved to its retracted position (FIG. 2) and, when the tool holder 34 has cooled sufficiently for safe handling, the tool holder 34 is removed from the fixture 18. Thereafter, the procedure can be repeated using either the same reference tool 30 and same reference holder 26, or a different reference holder 26 and different reference tool 30.

From the foregoing, it can be seen that the present invention provides a simple and yet highly accurate device for positioning the cutting tool in a heat shrink tool holder at the same position as a reference tool in a reference holder. Having described my invention, however, many modifications thereto will become apparent to those skilled in the art to which it pertains without deviation from the spirit of the invention as defined by the scope of the appended claims.

I claim:

1. A device for setting a shank of a rotary cutting tool in a throughbore of a shrink fit tool holder so that the rotary cutting tool shank is at the same position as a shank of a reference tool positioned in a throughbore of the reference holder, said device comprising:
a housing having a first station and a second station laterally spaced from said first station;
a first fixture mounted to said housing at said first station and adapted to receive and support the reference holder at a predetermined position, said first fixture having an opening aligned with the reference holder throughbore;
a second fixture mounted to said housing at said second station and adapted to receive and support the tool holder at a predetermined position, said second fixture having an opening aligned with the tool holder throughbore;
a first rod movably mounted to said housing along an axis aligned with said first fixture opening;
a second rod movably mounted to said housing along an axis aligned with said second fixture opening;
a cross beam secured to said first and second rods so that said rods move in unison with each other;
means for moving said cross beam;
means for heating said tool holder; and
means for positioning said rotary cutting tool shank into the tool holder throughbore while said tool holder is heated above a preset temperature.

2. The invention as defined in claim 1 wherein said moving means comprises a threaded shaft rotatably mounted to said housing, said shaft threadably engaging a threaded bore in said cross beam, and means for rotatably driving said threaded shaft.

3. The invention as defined in claim 2 wherein said rotatable driving means comprises an electric motor.

4. The invention as defined in claim 2 wherein said threaded shaft comprises a ball screw.

5. The invention as defined in claim 1 wherein one end of said first rod is positioned within said reference holder throughbore, and wherein one end of said second rod is positioned within said tool holder throughbore.

6. The invention as defined in claim 1 wherein said heating means comprises means for inductively heating said tool holder.

7. The invention as defined in claim 1 wherein said positioning means comprises an elongated support secured to said housing adjacent said second station, a conveyor mounted to said support and movable between an upper and a lower position, means on said conveyor for selectively engaging the rotary cutting tool, wherein in said lower position said conveyor positions the shank of the rotary cutting tool in the tool holder throughbore.
